(19) United States
(12) Patent Application Publication
(10) Pub. No.: US 2014/0257597 A1
(43) Pub. Date: Sep. 11, 2014

(54) INTERFACE SYSTEM FOR MULTIPLE PROTOCOLS

(71) Applicant: PRATT & WHITNEY CANADA CORP., Longueuil (CA)

(72) Inventors: Jonathan MILLER, Natick, MA (US); Richard Brian WIRTH, Stoney Creek (CA)

(73) Assignee: PRATT & WHITNEY CANADA CORP., Longueuil (CA)

(21) Appl. No.: 13/793,268

(22) Filed: Mar. 11, 2013

(51) Int. Cl. G05D 1/00

(52) U.S. Cl. CPC G05D 1/00
USPC 701/3

(57) ABSTRACT

An interface system for a plurality of different protocols. The system includes a single receiver, a processor and a single transmitter. The receiver may convert an input signal to a 1/0 signal according to a determined one of the plurality of different protocols. The processor may receive the converted logic level signal and parse the converted logic level signal into data according to the determined one protocol. The transmitter may receive the translated signal and convert the translated signal to an output signal having a format readable by an external device.

### TECHNICAL FIELD

The disclosure relates generally to interface systems for electronic controls for aircraft engines. In particular, this disclosure relates to interface systems for such controls implemented using multiple protocols.

### BACKGROUND OF THE ART

In the aviation industry, various engines and components associated with such engines may operate according to, and provide, data using different protocols (e.g., RS232, RS423, RS422, ARINC 429 LS, ARINC 429 HS among others). Often, it is not known by maintenance and repair personnel beforehand what protocol a given engine, or engine component, may employ, making it difficult to carry out in-the-field diagnosis of engines and associated problems. Thus repair and maintenance personnel may be stymied or delayed in interpreting diagnostic and other signals, with resultant loss of efficiency and effectiveness in maintenance and repair processes.

Conventional data interface systems suitable for use with multiple protocols typically require a separate receiver and transmitter circuit, and a dedicated set of connections, for use with each protocol. An example is shown in FIG. 3, which shows a conventional interface system that may receive data signals with two different protocols. There is one receiver/transmitter pair for one protocol, and a second receiver/transmitter pair for the second protocol. Each receiver/transmitter pair also includes its own set of receiver pins (Rx) and transmitter pins (Tx). A selector circuit is typically required to choose which receiver/transmitter is to be used. Such an interface system can quickly become large and complicated if required to support multiple different protocols, leading to increased costs, size and/or possibility of wiring error and component failure.

A ground crew obtaining data from an aircraft engine often does not know beforehand the electrical nor the data protocol used by the engine. It is often tedious and impractical for a crew member to carry multiple different interface systems, to accommodate different possible electrical and data (e.g. communication) protocols.

Improvement is therefore desirable.

### SUMMARY

The present disclosure describes systems for interfacing with multiple transmission protocols.

In various aspects and example embodiments, the disclosure describes an interface system for a plurality of different protocols. The system comprises:
a single receiver for converting an input signal to a 1/0 signal according to a determined one of the plurality of different protocols, and for providing a converted logic level signal;
a processor communicating with the receiver and receiving the converted logic level signal, the processor configured for parsing the converted logic level signal into data according to the determined one protocol, and for providing an instruction signal; and
a single transmitter communicating with the processor and receiving the instruction signal, the transmitter being for converting the instruction signal to an output signal having a format readable by an external device, and for providing the output signal.

Further details of these and other aspects of the subject matter of this application will be apparent from the detailed description and drawings included below.

### DESCRIPTION OF THE DRAWINGS

Reference is now made to the accompanying drawings, in which:

FIG. 1 is a block diagram which illustrates an example of how an electronic engine control may provide data;

FIG. 2 is an example of the disclosed interface system for multiple protocols; and

FIG. 3 is an example of a prior art interface system.

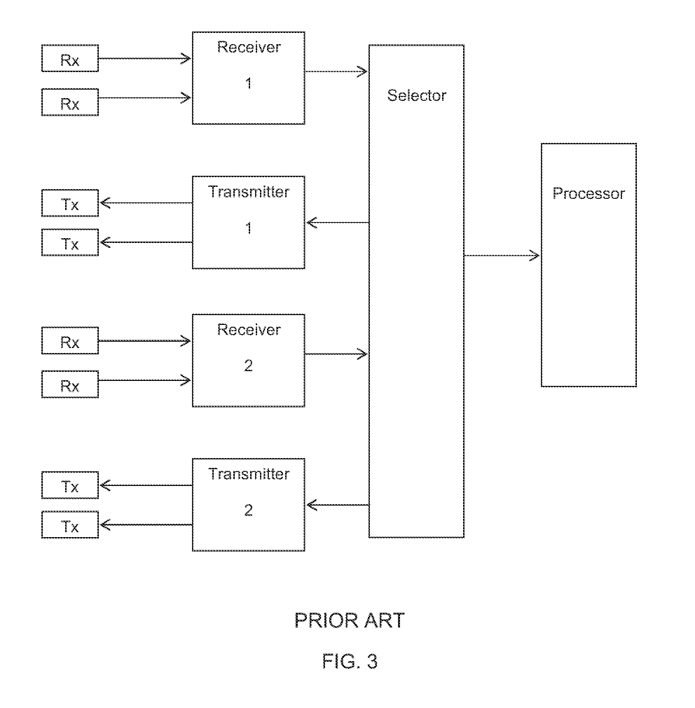

### DETAILED DESCRIPTION

Aspects of various embodiments are described through reference to the drawings.

In the aviation industry, different engines may employ different electrical protocols and/or different data (e.g., communication) protocols (e.g., RS232, RS423, RS422, ARINC 429 LS, ARINC 429 HS among others) for transferring data between avionic systems and ground support equipment (GSE), for example. Different interface (e.g., data transmission) protocols may make use of different bus configurations (e.g., one or two conductors), different voltage levels for signalling a 1/0 bit (e.g., 0V or −5V for signalling a 0 bit), different voltage ranges, balanced or single ended, and/or different signal timing. Engine data may be transmitted on ground for diagnostic and/or prognostic purposes. Ground crew may benefit from a portable, compact and/or reconfigurable interface system for interfacing with different aircraft engines and other avionic systems.

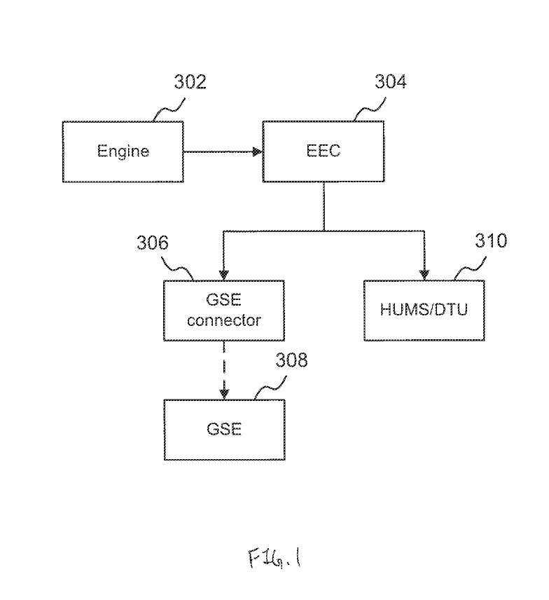

FIG. 1 illustrates an example of how an electronic engine control may provide data. The electronic engine control 304 (EEC) may provide data from an engine 302 (e.g., an aircraft engine), such as for monitoring and maintenance purposes. This data may be provided to GSE 308, for example via a GSE connector 306, as well as to any Health Usage Monitoring System or Digital Transmission Unit (HUMS/DTU) 310, for example. A data interface system, as presently disclosed, may be used to enable a communication interface between the EEC 304 and the GSE 308 and/or HUMS/DTU 310. An example of the disclosed interface system may be implemented in the GSE connector 306 as a means of providing a common interface to a higher level analysis support system, for example.

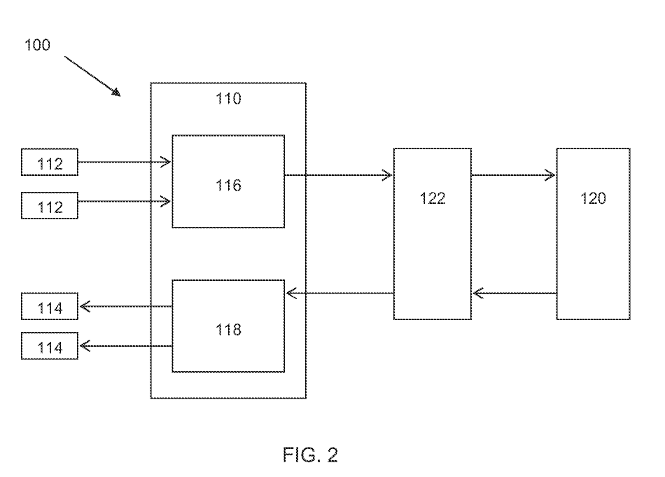

FIG. 2 shows an example of an interface system 100 capable of interfacing with multiple data busses. The example interface system 100 includes a receiver/transmitter component 110 and a processor 120 (e.g., microprocessor executing appropriate software instructions) or a programmable gate array, for example. The processor 120 may be in communication with (e.g., electrically coupled to) the receiver/transmitter component 110. The receiver/transmitter 110 may include one or more receiver pins 112 (e.g., one or two, or more) for receiving input data signals from an engine, and one or more transmitter pins 114 (e.g., one or two, or more) for providing output data signals, for example to the engine to set modes of operation. The receiver/transmitter 110 may include a receiver module 116 (e.g., implemented in an array processor) to carry out a receiver function; and a transmitter module 118 (e.g., implemented in an array processor) to carry out a transmitter function. The processor 120 may be in communication with the receiver module 116 and also in communication with the transmitter module 118. Although not shown, the receiver/transmitter 110 may include one or more buffers for buffering data received and/or data to be transmitted. The interface system 100 may also include a clock 122.

Input signals received at the receiver pin(s) 112 may be received at the receiver module 116, which may perform electrical sampling and/or voltage level translation of the received signals and may (e.g., with assistance of the clock 122, which may parse timing characteristics of the signal) convert the received signals into a converted signal (e.g., 1/0 binary signal) that may be accepted by the processor 120. The receiver module 116 may perform this conversion according to a determination of the electrical and/or data protocol used by the input signals. The determined protocol(s) may be automatically determined by the receiver module 116 and/or selected by a user, for example as described further below. If correct translation of a protocol is not achieved (e.g., a verification such as a checksum calculation fails), the receiver module 116 may attempt an alternate translation to achieve appropriate conversion.

The receiver module 116 may recognize a plurality of different electrical and/or data protocols. For example, the receiver module 116 may have access to a memory that stores information for characterizing and/or parsing the different protocols (e.g., including expected 1/0 translation of known protocols). This may be modified as necessary (e.g., using appropriate reprogramming techniques) to add, modify or remove a protocol from those recognized by the receiver module 116. In cases where the receiver module 116 is unable to determine the protocol of the received signals, the receiver module 116 may provide information about the characteristics of the received signals (e.g., to the processor 120) and may cause a notification to be generated (e.g., to request a user to program in a new protocol).

The processor 120, after appropriate processing of the converted signals, may provide instruction signals (e.g., representing one or more requests for data) to the transmitter module 118, to be outputted (e.g., to the engine 302). The transmitter module 118 may (e.g., with assistance of the clock 122, which may implement timing control to adapt to the determined protocol) in turn convert the instructions signals to appropriate output format (e.g., appropriate voltage ranges and/or timing) according to the determined protocol(s). The transmitter module 118 may provide the converted output signals to the transmitter pin(s) 114. In some examples, the transmitter module 118 may also provide protection against inadvertent short or open circuit conditions.

The interface system 100 may include one or more memories (not shown) and/or memory data devices or register(s), which may be coupled to and/or included in the receiver module 116, transmitter module 118 and/or processor 120. Memory(ies) may comprise any storage means (e.g. devices) suitable for retrievably storing data and/or machine-readable instructions executable by the receiver module 116, transmitter module 118 and/or processor 120. Memory(ies) may be non-volatile. For example, memory(ies) may include erasable programmable read only memory (EPROM) flash memory(ies) or other electromagnetic media suitable for storing electronic data signals in volatile or non-volatile, non-transient form. Memory(ies) may also be used to implement one or more transient storage (e.g., a buffer) for active signals being received.

The receiver pin(s) 112 and/or the receiver module 116 may be configured to accept a range of different input signals that may be used by different protocols. For example, the receiver pin(s) 112 and/or the receiver module 116 may be configured to handle different voltage and/or current ranges (e.g., different voltage magnitudes, including positive and negative voltages) that may be expected from different electrical protocols.

The number of receiver pin(s) 112 may be designed to accommodate various different interface busses. For example, one buss type may require the use of two pins 112, while another buss type may require the use of a single pin 112. In order to accommodate both buss types, the interface system 100 may be designed with at least two receiver pins 112.

Similarly, the number of transmitter pin(s) 114 may be designed to accommodate busses requiring different numbers of pins.

In some examples, the receiver module 116 may include logic (e.g., hardwired logic and/or programmable logic) for automatically determining (i.e., without requiring pre-configuration or other determination by a user or other external source) the protocol used by the input data signals. For example, the receiver module 116 (optionally together with the clock 122) may include logic that detects one or more characteristics (e.g., voltage range, timing of voltage changes and/or number of receiver pins 112 used) of the received input signals and compares such detected characteristic(s) against the known characteristic(s) of different protocols (e.g., using information about the protocols stored in a memory coupled to the receiver module 116) to make a determination of the protocol used by the received input signals. Characteristics may include, for example, different voltage levels (e.g., a differential voltage—that is, signal to signal—or single ended voltage—that is, signal to common ground reference) or different clock recovery methods to determine the 1/0 of the data stream.

In some examples, the receiver module 116 may be pre-configured and/or configured on-the-fly (e.g., when already connected to an engine), by a user or other external source, for example, to receive and convert a certain determined protocol. For example, if a user is aware that a certain engine uses a given protocol, the user may manually pre-configure the receiver module 116 (e.g., using a manual selector, such as a switch, provided on the interface system 100, or by pre-programming the interface system 100) to receive and convert input signals using the given protocol.

The receiver module 116 (optionally together with the clock 122) may output the converted logic level signal in the form of 1/0 values that may be accepted by the processor 120 (e.g., using voltage ranges acceptable by the processor 120). The converted signal may include additional information, for example information used for further decoding of the information in the data stream (e.g., for embedded clock recover), to enable the processor 120 to appropriately handle the converted signal.

The processor 120 may receive the converted signal from the receiver module 116 through clock 122. The processor 120 may translate the 1/0 values of the converted signal into data and may provide the translated signal and/or instructions signals (to configure the transmitter module 118) to the transmitter module 118. The processor 120 may process the converted signal according to the determined protocol (e.g., as identified by the receiver module 116).

The transmitter module 118 (optionally together with the clock 122) may then convert the translated signal into output signals with a suitable format (e.g., with appropriate voltage levels and timing) to be outputted to an external diagnostic device, for example.

In some examples, the output signals may include information about the determined protocol(s) of the input signals. For example, the output signals may include a header (that may be appended by the processor 120) including information identifying the protocol and/or the signal characteristic(s) used by the input signals.

The interface system 100 may be configured to support various protocols including protocols used in aircraft engines, for example, RS232, RS423, RS422, ARINC 429 LS, ARINC 429 HS among others. Mixed types of data interface protocols may thus be supported in a common circuit design in the interface system 100. The interface system 100 may be programmable (e.g., using a connection to an external device) to modify the protocols supported including, for example, the addition of protocols, removal of protocols and/or modification of protocols. Thus, the interface system 100 may be adaptable for use with not-yet-developed protocols, as well as to remove obsolete protocols.

The presently disclosed interface system may provide one or more advantages over conventional systems.

The disclosed interface system may be more efficient than conventional interface systems. For example, conventional interface systems may require separate sets of pins dedicated to different protocols, which may result in a more expensive, larger and/or more error-prone interface system. The presently disclosed interface system may allow the same receiver pin(s) to be used for different protocols, allowing for a smaller number of interface circuit pins and connections, thereby helping to reduce the package and/or connector size, overall cost and/or possibility of error and/or component failure.

The disclosed interface system may also help to simplify application engineering by enabling larger channel counts that suits the requirements. For example, an application may be required only to match the total number of generic interface ports.

The present disclosure may allow for data to be received from an aircraft engine without needing any pre-knowledge about the protocol used by the engine and/or without any requiring explicit selection of a protocol by the user.

The disclosed interface system may be adaptable (e.g., using appropriate reprogramming) to accommodate the addition of new protocols and/or modifications to existing protocols. This may not be possible or may be difficult using conventional interface systems.

The disclosed interface system may be useful in the aviation industry, where different aircraft engines may have different custom protocols, which may be unknown to a ground crew performing diagnostics on the engine.

The above description is meant to be exemplary only, and one skilled in the art will recognize that changes may be made to the embodiments described without departing from the scope of the invention disclosed. For example, although the disclosed interface system has been illustrated as being implemented using certain electronic components, other configurations and/or components may be used. Still other modifications which fall within the scope of the present invention will be apparent to those skilled in the art, in light of a review of this disclosure, and such modifications are intended to fall within the appended claims.

1. An interface system for a plurality of different protocols, the system comprising:
a single receiver for converting an input signal to a 1/0 signal according to a determined one of the plurality of different protocols, and for providing a converted logic level signal;
a processor communicating with the receiver and receiving the converted logic level signal, the processor configured for parsing the converted logic level signal into data according to the determined one protocol, and for providing an instruction signal; and
a single transmitter communicating with the processor and receiving the instruction signal, the transmitter being for converting the instruction signal to an output signal having a format readable by an external device, and for providing the output signal.

2. The system of claim 1 further comprising a clock configured for receiving the converted logic level signal from the receiver, further parsing the converted logical level signal according to a timing characteristic of the determined one protocol, and providing the parsed converted logic level signal to the processor.

3. The system of claim 2, wherein the clock is further configured for receiving the instruction signal from the processor, converting the instruction signal according to the timing characteristic, and providing the converted instruction signal to the transmitter.

4. The system of claim 1 wherein the input signal is received from an electronic engine control of an aircraft engine.

5. The system of claim 1 wherein the output signal is provided to an external avionics system.

6. The system of claim 1 wherein the receiver is configured to determine the determined protocol based on one or more characteristics of the input signal.

7. The system of claim 6 wherein the one or more characteristics include at least one of a voltage range, a number of receiver pins used, and a voltage change timing.

8. The system of claim 1 further comprising at least one receiver pin electrically coupled to the receiver, for receiving the input signal.

9. The system of claim 8 wherein there is a plurality of receiver pins, the number of receiver pins corresponding to at least a maximum number required by the different protocols.

10. The system of claim 9 wherein there are at least two receiver pins.

11. The system of claim 1 further comprising at least one transmitter pin electrically coupled to the transmitter, for providing the output signal.

12. The system of claim 11 wherein there is a plurality of transmitter pins, the number of transmitter pins corresponding to at least a maximum number required by the different protocols.

13. The system of claim 1 wherein the different protocols include at least one of: RS232, RS423, RS422, ARINC 429 LS and ARINC 429 HS.

14. The system of claim 1 wherein the converted logic level signal provided by the receiver to the processor includes information for further decoding the converted logic level signal.

15. The system of claim 1 wherein the determined protocol is selectable by a user.

16. The system of claim 1, wherein the receiver is programmable to add, modify or remove a protocol from the plurality of different protocols recognized by the receiver.

17. The system of claim 1, wherein the different protocols comprise one or more electrical protocols.

18. The system of claim 1, wherein the different protocols comprise one or more data protocols.
